(19) United States
(12) Patent Application Publication
(10) Pub. No.: US 2009/0167549 A1
(43) Pub. Date: Jul. 2, 2009

(54) INSTALLATION INDICATOR FOR A SELF SUFFICIENT POWER SUPPLY

(76) Inventors: Donald Edward Becker, Bradenton, CA (US); William Edwards, Bradenton, FL (US)

Correspondence Address: General Electric Company;GE Global Patent Operation, PO Box 861, 2 Corporate Drive, Suite 648, Shelton, CT, 06484, US

(21) Appl. No.: 11/967,812

(22) Filed: Dec. 31, 2007

(51) Int. Cl. G08B 21/00

(52) U.S. Cl. 340/679

(57) ABSTRACT

An apparatus includes a self sufficient power supply providing power to the apparatus when a main power supply is faulty, and an indicator adjacent to terminals of the apparatus that indicates when the self sufficient power supply is incorrectly connected to the terminals. In addition, a method includes installing a self sufficient power supply to provide power to an apparatus when a main power supply is faulty, and providing an indicator adjacent to terminals of the apparatus that indicates when the self sufficient power supply is incorrectly connected to the terminals.

### BACKGROUND

1. Field of the Invention

The disclosed embodiments relate to systems with self sufficient power supplies.

2. Description of Prior Art

Many systems include a self sufficient power supply in order to maintain operations when a main power supply is faulty or interrupted. For example, a typical fire safety system generally includes a battery backup in order to maintain fire safety coverage when adequate AC mains power is not available. Other types of systems including life support and computer systems may also include self sufficient power supplies. A problem arises when the self sufficient power supply is incorrectly installed. In some instances, the system may be damaged. Even in systems that may be protected against incorrect installation, significant time and effort may be required to diagnose and correct the problem. This may be made more difficult if the system provides a non-specific fault indicator. In a large system, this may be further complicated if the self sufficient power supply is remote from the main panel that indicates the fault.

It would be desirable to provide immediate feedback in the event that a self sufficient power supply is incorrectly installed.

### SUMMARY

In one exemplary disclosed embodiment, an apparatus includes a self sufficient power supply providing power to the apparatus when a main power supply is faulty, and an indicator adjacent to terminals of the apparatus that indicates when the self sufficient power supply is incorrectly connected to the terminals.

In another exemplary disclosed embodiment, a method includes installing a self sufficient power supply to provide power to an apparatus when a main power supply is faulty, and providing an indicator adjacent to terminals of the apparatus that indicates when the self sufficient power supply is incorrectly connected to the terminals.

### BRIEF DESCRIPTION OF THE DRAWINGS

The foregoing aspects and other features of the presently disclosed embodiments are explained in the following description, taken in connection with the accompanying drawings, wherein:

FIG. 1 shows a block diagram of a system suitable for practicing the disclosed embodiments;

FIG. 2 shows an exemplary power system for use with a supported system;

FIG. 3 shows a block diagram of an exemplary self sufficient power supply;

FIG. 4 shows a block diagram of one embodiment of an installation indicator;

FIG. 5 shows another embodiment of an installation indicator; and

FIG. 6 shows a flow diagram of operations according to the disclosed embodiments.

### DETAILED DESCRIPTION

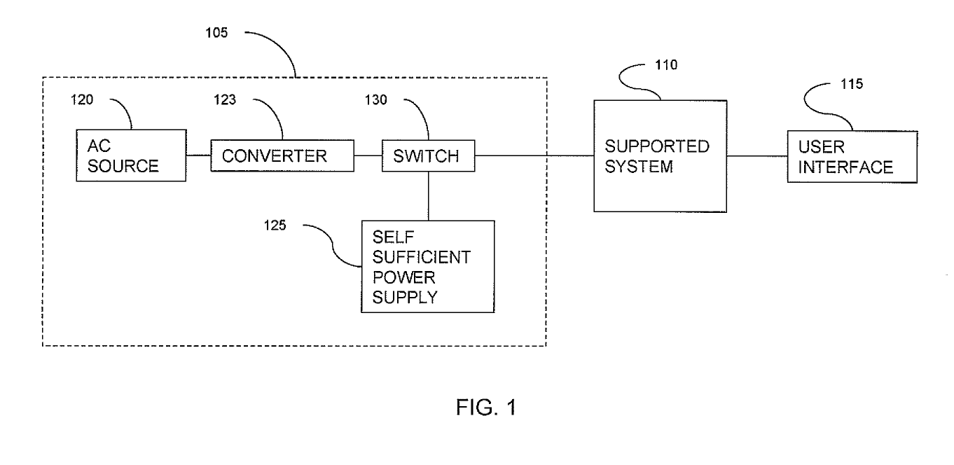

FIG. 1 shows a block diagram of an exemplary system 100 suitable for practicing the embodiments disclosed herein. Although the presently disclosed embodiments will be described with reference to the drawings, it should be understood that they may be embodied in many alternate forms. It should also be understood that in addition, any suitable size, shape or type of elements or materials could be used.

The disclosed embodiments are directed to providing more immediate feedback in the event that a self sufficient power supply is installed incorrectly. The self sufficient power supply may include, for example, one or more batteries, fuel cells, solar cells, generators, alternators, or any type of device or system that provides power to a load. The load may include any system that may require a self sufficient power supply, referred to herein as a supported system. Exemplary supported systems may include fire safety systems, life safety systems, life support systems, computer systems, etc. A fire safety system or life safety system may include any system designed to minimize danger to life from fire, smoke, fumes, panic, or other conditions harmful to life. Life support systems may include systems for sustaining life including mechanical respiration machines, heart lung bypass machines, defibrillators, etc. Any other systems that may require a self sufficient power supply are also included.

FIG. 1 shows a typical system 100 that may utilize a self sufficient power supply. The system 100 may include an exemplary power system 105, a supported system 110, and a user interface 1 15. The power system 105 may include an AC mains power source 120, a regulator 123 a self sufficient power supply 125, and a switch 130. The AC mains power source 120 may include any readily available electrical power supply and is typically provided by a power utility company. The regulator 123 operates to convert the power from the AC mains power source 120 to DC power. The switch 130 generally operates to switch between the regulator 123 and the self sufficient power supply 125. The switch may include a sensing mechanism and if the DC power from the regulator 123 becomes unsuitable for the supported system 110, the switch 130 may switch from the regulator 123 to the self sufficient power supply 125. The switch 130 may also operate to restore power from the regulator 123 and isolate the self sufficient power supply 125 if the regulator 123 again becomes suitable for use. The operations of the power system 105 may be transparent to the supported system 110, or the supported system 110 may change operating parameters when power is supplied by the self sufficient power supply 125. The user interface 115 may include input and output devices for controlling and determining the status of the supported system 1 10. The user interface 115 may be remote from the supported system 110 and may also be remote from the self sufficient power supply 125.

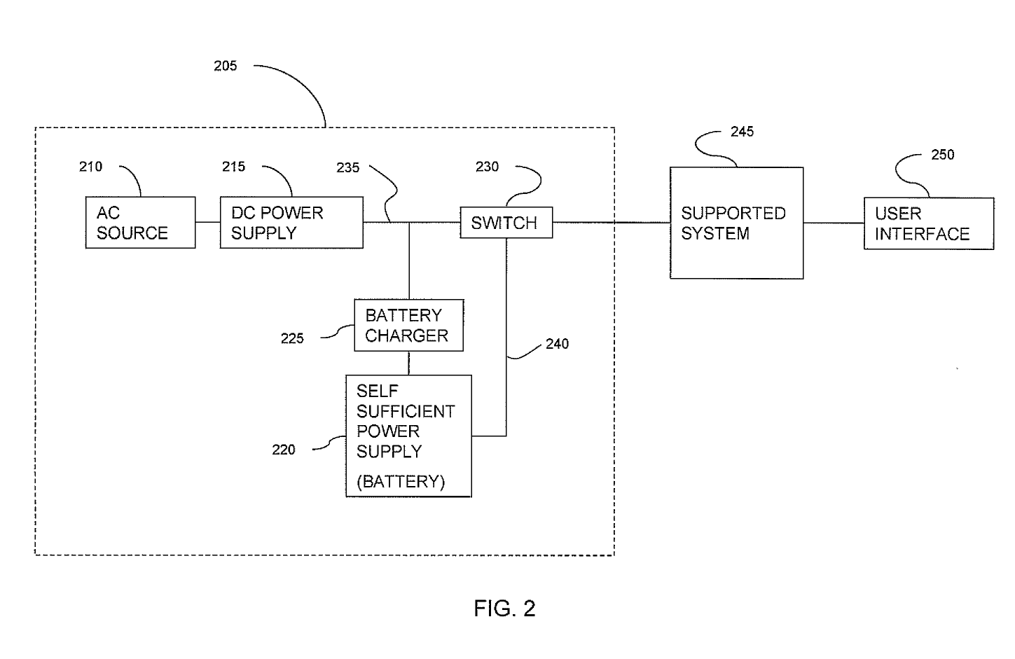

FIG. 2 shows another exemplary power system 205 for use with a supported system 245. Power system 205 includes an AC mains power source 210, a DC power supply 215, a self sufficient power supply 220 in the form of a battery, a battery charger 225 and a power switch 230 connected to a supported system 245. The AC mains power source 210 may be similar to AC mains power source 120 above. In this embodiment, the AC mains power source 210 is connected to the DC power supply 215 which converts the AC power to a primary DC power output 235. The battery charger 225 utilizes the DC power output 235 to charge the self sufficient power supply 220. The self sufficient power supply 220 provides a backup DC power output 240. The power switch 230 generally operates to switch between the primary DC power output 235 and the backup DC power output 240 if the primary DC power output 235 becomes unsuitable for the supported system 245. The supported system 245 may be similar to the supported system 110 described above and may include a user interface 250. Similar to the user interface 115 above, the user interface 250 may be remote from the supported system 245 and may also be remote from the self sufficient power supply 220.

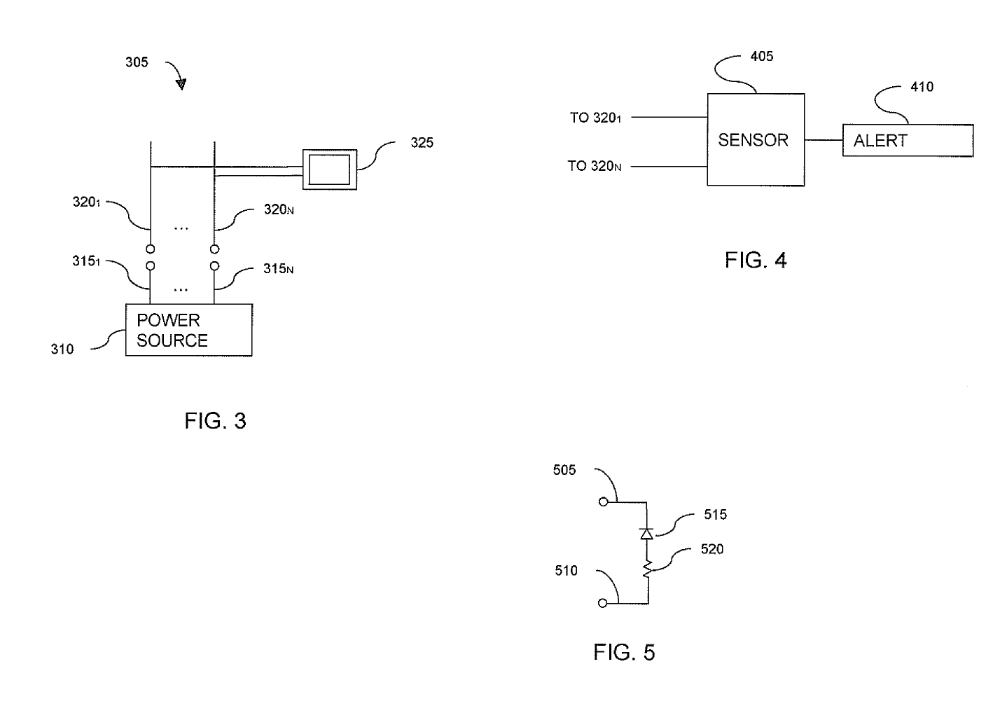

FIG. 3 shows a block diagram of an exemplary self sufficient power supply 305 as disclosed herein, including self sufficient power supplies 125 and 220. Self sufficient power supply 305 includes a power source 310, for example, one or more batteries, fuel cells, solar cells, generators, alternators, or any type of device or system that provides power, as mentioned above. The power source 310 generally includes a plurality of terminals 315₁ . . . 315ₙ that may be connected to corresponding system terminals 320₁ . . . 320ₙ during installation. System terminals 320₁ . . . 320ₙ may be connected to switch 130, or one or more of switch 230 and battery charger 225, An installation indicator 325 may be located adjacent the system terminals 320₁ . . . 320ₙ that provides a substantially immediate indication if the power source 310 is installed incorrectly. The indication may be visual, auditory, or any other suitable indication that notifies an installer that the power source 310 has been installed incorrectly. For example, the installation indicator 325 may be electrically connected to the system terminals 320₁ . . . 320ₙ and may sense improper electrical voltage or current at one or more of the system terminals 320₁ . . . 320ₙ. Upon sensing the improper voltage or current the installation indicator 325 may initiate a signal, immediately alerting the installer that the power source 310 is incorrectly installed.

FIG. 4 shows a block diagram of one embodiment of the installation indicator 325. A sensor 405 may be connected to the system terminals 320₁ . . . 320ₙ which is capable of sensing any number of improper installation conditions, for example, improper voltage, current, polarity, temperature, etc. The installation indicator 325 may also include a device 410 connected to the sensor 405 that provides an alert, for example, a speaker, buzzer, light, etc.

FIG. 5 shows another embodiment of the installation indicator 325 where the sensor and the alerting device are combined as a single device. In this embodiment, an LED 515 and an optional resistor 520 are connected in series with two of the system terminals 505, 510. In the event that the power source 310 has been installed in reverse polarity, the LED will sense the reversed polarity and light, thus providing an immediate indication of the installation fault.

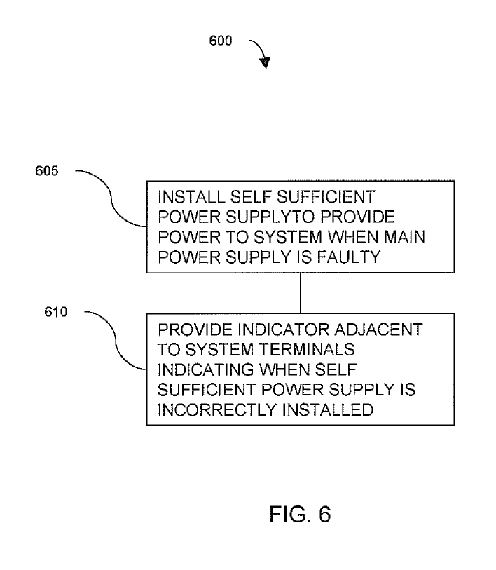

FIG. 6 shows a flow diagram 600 of operations according to the disclosed embodiments. Block 605 shows installing a self sufficient power supply to provide power to a system when a main power supply is faulty. In block 610 an indicator is provided adjacent to terminals of the system that indicates when the self sufficient power supply is incorrectly connected to the terminals.

Thus, the disclosed embodiments prove more immediate feedback in the event that a self sufficient power supply has been installed incorrectly. Productivity is improved by more immediately indicating that the self sufficient power supply has been installed incorrectly, while the installer is present and able to correct the problem, in a timely manner that may prevent damage to the supply or to other system components, and without the need to review indications on a control panel that may be remote from the self sufficient power supply. This productivity improvement may reduce average system installation time, and as a result may reduce average system installed cost.

It should be understood that the foregoing description is only illustrative of the present embodiments. Various alternatives and modifications can be devised by those skilled in the art without departing from the embodiments disclosed herein. Accordingly, the embodiments are intended to embrace all such alternatives, modifications and variances which fall within the scope of the appended claims.

What is claimed is:

1. An apparatus, comprising:
a self sufficient power supply providing power to the apparatus when a main power supply is faulty; and
an indicator adjacent to terminals of the apparatus that indicates when the self sufficient power supply is incorrectly connected to the terminals.

2. The apparatus of claim 1, further comprising a fire safety system.

3. The apparatus of claim 1, further comprising a life safety system.

4. The apparatus of claim 1, further comprising a life support system.

5. The apparatus of claim 1, wherein the self sufficient power supply comprises one or more batteries.

6. The apparatus of claim 1, wherein the self sufficient power supply comprises one or more fuel cells.

7. The apparatus of claim 1, wherein the self sufficient power supply comprises one or more solar cells.

8. The apparatus of claim 1, wherein the indicator comprises:
a sensor for sensing improper installation conditions; and
a device connected to the sensor for providing an alert.

9. The apparatus of claim 8, wherein the sensor and device for providing an alert are combined in a single device.

10. A method, comprising:
installing a self sufficient power supply to provide power to an apparatus when a main power supply is faulty; and
providing an indicator adjacent to terminals of the apparatus that indicates when the self sufficient power supply is incorrectly connected to the terminals.

11. The method of claim 10, wherein the apparatus is a fire safety system.

12. The method of claim 10, wherein the apparatus is a life safety system.

13. The method of claim 10, wherein the apparatus is a life support system.

14. The method of claim 10, wherein the self sufficient power supply comprises one or more batteries.

15. The method of claim 10, wherein the self sufficient power supply comprises one or more fuel cells.

16. The method of claim 10, wherein the self sufficient power supply comprises one or more solar cells.

17. The method of claim 10, wherein providing an indicator adjacent to terminals of the apparatus includes:
providing a sensor for sensing improper installation conditions; and
providing a device connected to the sensor for providing an alert.

18. The method of claim 17, further comprising combining the sensor and device for providing an alert in a single device.
